(19) United States
(12) Patent Application Publication
(10) Pub. No.: US 2010/0163078 A1
(43) Pub. Date: Jul. 1, 2010

(54) SPINNER AND METHOD OF CLEANING SUBSTRATE USING THE SPINNER

(75) Inventors: Tzu-Jeng Hsu, Taipei City (TW); Chi-Ming Yang, Hsian-San District (TW); Chyi Shyuan Chern, Taipei (TW)

Correspondence Address: DUANE MORRIS LLP (TSMC);IP DEPARTMENT, 30 SOUTH 17TH STREET, PHILADELPHIA, PA, 19103-4196, US

(73) Assignee: Taiwan Semiconductor Manufacturing Co., Ltd., Hsin-Chu (TW)

(21) Appl. No.: 12/347,433

(22) Filed: Dec. 31, 2008

(51) Int. Cl. B08B 7/04; B08B 3/02

(52) U.S. Cl. 134/33; 134/103.2

(57) ABSTRACT

A method includes spinning a semiconductor wafer about an axis normal to a major surface of the wafer. The wafer is translated in a direction parallel to the major surface with an oscillatory motion, while spinning the wafer. A material is sprayed from first and second nozzles or orifices at respective first and second locations on the major surface of the wafer simultaneously while spinning the wafer and translating the wafer.

### FIELD OF THE INVENTION

The present disclosure relates to semiconductor processing equipment.

### BACKGROUND

Conventional cleaning processes in a semiconductor wet bench process include spraying a solvent or water droplets onto a semiconductor wafer surface. The particles on the wafer surface are removed by the impingement of droplets against the particles. As wafer size increases, the impingement force may impact the device.

In particular, the pattern at the outer edge of the wafer is subjected to higher energy droplets, and is more likely to be damaged than the wafer center. The tangential speed at a given point on the wafer is proportional to the radial coordinate of the given point (in polar coordinates), and is given by tangential speed=radius X angular rotation rate (in radians per second). At the center, the tangential speed is zero. For a given rotational speed, a larger wafer size results in a higher tangential speed near the circumference of the wafer. Because the tangential speed of the wafer's edge is increased by larger wafer radius, the spinning process in a 450 mm wafer is affected by the droplet impact force due to the tangential speed component.

For example, if a nozzle sprays droplets vertically at about 20 meters/second onto a 200 mm wafer (100 mm radius) rotating at 26 radians/second, the tangential speed at the circumference is 2.6 m/second, and the velocity of the droplets relative to the wafer surface is calculated by the Pythagorean theorem as V=(20²+2.6²)^{1/2}=20.1 meters/second. This value is within 1% of the speed (20 meters/second) of the droplets relative to the wafer at the center of the wafer, where the tangential speed is zero. Thus, for a 200 mm wafer rotated at 26 radians/second, the variation in kinetic energy of the droplets impinging on different parts of the wafer was not a concern.

For a 450 mm wafer (225 mm radius) also rotating at 26 radians/second, the tangential speed at the circumference is 11.8 meters/second, and the velocity of the droplets relative to the wafer surface (given the same vertical spray speed) is V=(20²+11.8²)^{1/2}=23.3 meters/second. Thus, there is a 16% difference between the impingement speed of the droplets at the circumference (23.3 m/s) and the speed at the center (20 m/s). This increased impingement speed gives the droplets at the circumference a kinetic energy 34% higher than those at the center of the wafer. At some combinations of wafer rotation speed and droplet speeds, the increased kinetic energy of the droplets at the circumference may damage patterns (e.g., polycrystalline silicon lines) formed above the substrate.

### SUMMARY OF THE INVENTION

In some embodiments, a method comprises spinning a semiconductor wafer about an axis normal to a major surface of the wafer. The wafer is translated in a direction parallel to the major surface with an oscillatory motion, while spinning the wafer. A material is sprayed from first and second nozzles or orifices at respective first and second locations on the major surface of the wafer simultaneously while spinning the wafer and translating the wafer.

In some embodiments, a method comprises spinning a semiconductor wafer about an axis normal to a major surface of the wafer. At least one of the group consisting of the wafer and a pair of nozzles or orifices is translated in a direction parallel to the surface with an oscillatory motion, while spinning the wafer. A material is sprayed from the first nozzle and the second nozzle onto the surface of the wafer while simultaneously spinning the wafer and translating the wafer or first and second nozzles or orifices.

In some embodiments, a system comprises a spinner for spinning a semiconductor wafer about an axis normal to a major surface of the wafer. The spinner is capable of translating the wafer in a direction parallel to the major surface with an oscillatory motion, while spinning the wafer. At least two nozzles or orifices are provided for spraying a material onto the major surface of the wafer simultaneously at two locations while spinning and translating the wafer.

### BRIEF DESCRIPTION OF THE DRAWINGS

FIG. 1 is a schematic diagram of a spin base capable of simultaneous rotation and translation, with two nozzles for spraying a fluid.

FIGS. 2A to 2D show the path of the wafer relative to the nozzles during the oscillatory motion.

FIG. 3 is a flow chart of an exemplary method.

FIG. 4A is a diagram of a plurality of linearly arranged nozzles suitable for use in one embodiment.

FIG. 4B is a diagram of a shower head manifold having a plurality of orifices suitable for use in one embodiment.

FIG. 5 is a diagram showing the nozzles in alternative positions.

### DETAILED DESCRIPTION

This description of the exemplary embodiments is intended to be read in connection with the accompanying drawings, which are to be considered part of the entire written description. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

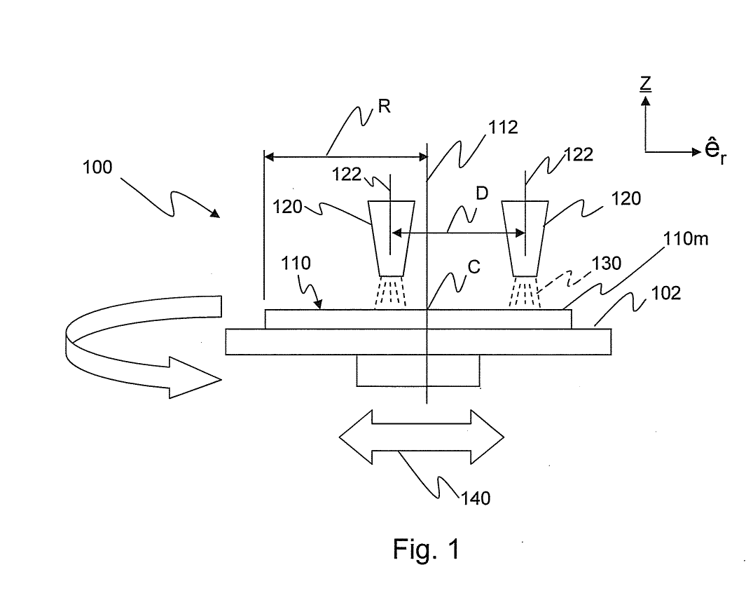

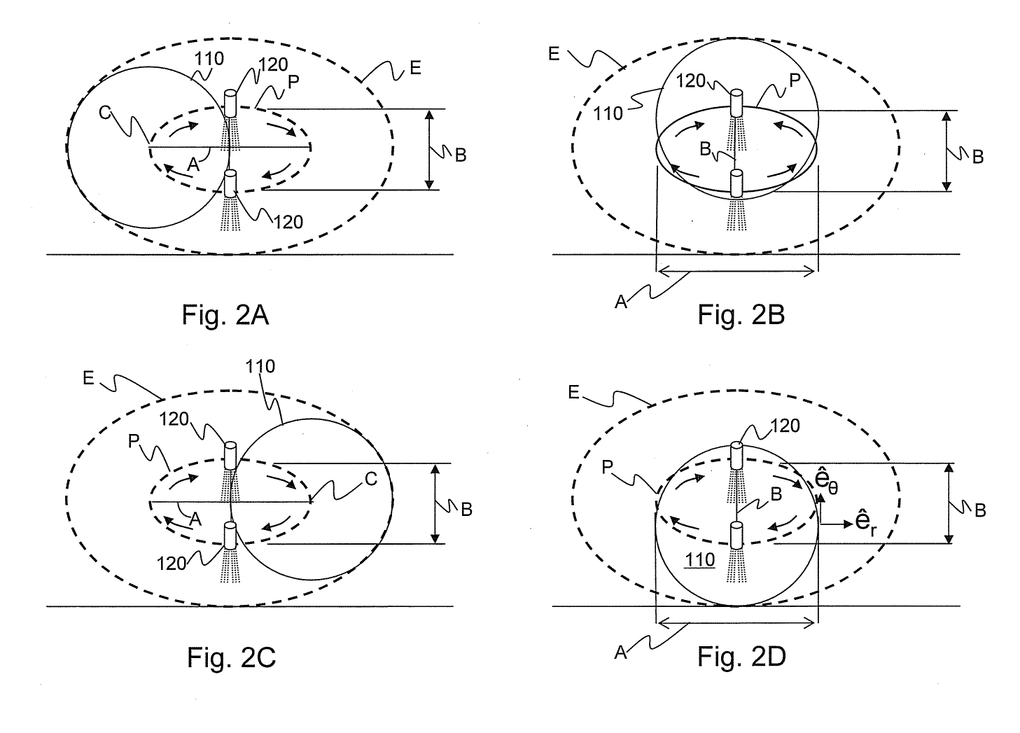

In the discussion below, discussion of direction and coordinates generally follow a polar coordinate system, in which the radial direction vector êᵣ is shown in FIGS. 1 and 2D, the tangential direction ê_{θ} is shown in FIG. 2D, and the vertical direction vector Z is shown in FIG. 1. In this polar coordinate system, the terms “above” and “below” refer to displacement in the Z direction. The phrases, “directly above” and “directly below” refer to displacements that include only a Z direction component in the local coordinate system, without a radial or tangential component. It is understood that this polar coordinate system is local, and the apparatus may be oriented in any direction within a global coordinate system.

FIG. 1 is a schematic diagram of an apparatus 100 and method for improving a spin-spray cleaning process or wet etching process for a semiconductor wafer 110. The apparatus 100 includes first and second nozzles 120 (and optionally, a third nozzle 120 or further additional nozzles) on a wafer spray-spinning system. The additional nozzle(s) 120, improves the uniformity of the driving force of a cleaning or etching solution on a large diameter wafer surface (e.g. 450 mm). For a larger diameter wafer 110, the tangential speed at the wafer edge is higher than the tangential speed near the center. This can result in a substantial difference between the relative speed of spray solvent dropping on the wafer surface at the wafer edge and the relative speed at the wafer center, and thus a substantial difference in kinetic energy of the impinging fluid droplets. Adding the second nozzle 120 can compensate for any limitation on the ability of the primary nozzle 120 to cover the wafer area and smooth the speed gap spray distribution. The smaller gap of drive force of solvent droplet can result in better uniformity between dies near the center and dies near the circumference of the wafer.

The system 100 comprises a spinner 102 for spinning a semiconductor wafer 110 about an axis 112 normal to a major surface 110m of the wafer. The spinner 102 is capable of translating the wafer 110 in a direction 140 parallel to the major surface 110m with an oscillatory motion, while spinning the wafer. The oscillatory motion translates the wafer 110 relative to the nozzles 120, so that the radial polar coordinate of the location where the spray impinges on the major surface of the wafer 110 varies from at or near the center C of the wafer 110 to at or near the circumference of the wafer.

In some embodiments, the oscillatory motion is such that a center C of the wafer 110 follows an elliptical path P (shown in FIGS. 2A to 2D), and the circumference of the wafer remains within an elliptical envelope E. The elliptical path P has a major axis A and a minor axis B.

For a wafer having a radius R, in some embodiments, the elliptical path P of center point C has a major axis A, such that 1.886R≦A≦2R (where 2R equals the diameter of the wafer), and a minor axis B, such that 0.22R≦B≦R.

In other embodiments, the oscillatory motion may have a different type of path. For example, in some embodiments, A=B, so that the path of the center point C is circular.

In other embodiments (not shown), the oscillatory motion is straight back and forth along a line segment. For example, given a plurality of nozzles 120 arranged along a line segment, the oscillatory motion may follow a line segment back and forth along a line segment below (in the Z direction) and parallel to the line segment containing the nozzles. In another embodiment, the oscillatory motion may follow a line segment back and forth along a line segment below and perpendicular to the line segment containing the nozzles.

In addition to the capability of oscillatory motion, the system 100 has at least two nozzles 120 or orifices for spraying a material 130 onto the major surface of the wafer 110 simultaneously at two locations while spinning and translating the wafer 110. In some embodiments, the at least two nozzles 120 or orifices are both oriented in the same direction, so that the longitudinal axes 122 of the at least two nozzles 120 or orifices are parallel to each other. In some embodiments, the fluid 130 is dispensed normal to the wafer surface, so that the fluid velocity vector has a Z component, but no radial or tangential component. In other embodiments, the nozzles or orifices may be positioned so that the fluid is dispensed from the nozzle or orifice with a tangential and/or radial velocity component. In some embodiments, the fluid spray fans out, so that the velocity vector is not uniform across the face of the nozzle or orifice.

For brevity, in the remainder of the discussion of FIGS. 1-3 and 5, the term “nozzles” is used to refer collectively to nozzles or orifices. One of ordinary skill will understand that the discussion of FIGS. 1-3 and 5 below applies equally to both nozzles and orifices.

Preferably, the distance D, by which the at least two nozzles 120 are separated from each other, is sufficient so that the spray from the first nozzle 120 does not overlap the spray from the second nozzle 120. Thus, at any given time, the at least two nozzles 120 dispense fluid to two distinct regions of the major surface of the wafer 110. In other embodiments, there is a relatively small region where the two sprays 130 intersect. Preferably, the area of any overlap region is much smaller than the area of either spray 130, to minimize non-uniformity of coverage.

In some embodiments, the at least two nozzles 120 are separated from each other by a distance that is greater than or equal to 0.886R, and is less than or equal to R, where R is a radius of the wafer 110.

The at least two nozzles 120 may be positioned in a variety of locations. In some embodiments, the nozzles 120 are positioned substantially directly above or substantially directly below a portion of the wafer along the major axis A of the elliptical path P through which the center C of the wafer 110 moves. (Here, “above” refers to displacement in the Z direction in FIG. 1). In some embodiments, the at least two nozzles 120 are arranged directly above or below the minor axis B, symmetrically about the major axis A, as shown in FIGS. 2A to 2D. In some embodiments, the positions of the nozzles 120 may be slightly off of the axis B, which do not substantially affect the coverage of the fluid on the wafer, taking into account the movement of the wafer. In other embodiments, the nozzles may be positioned above or below a portion of the wafer off of the axis B, and the oscillatory motion may be adjusted to compensate for the off axis position.

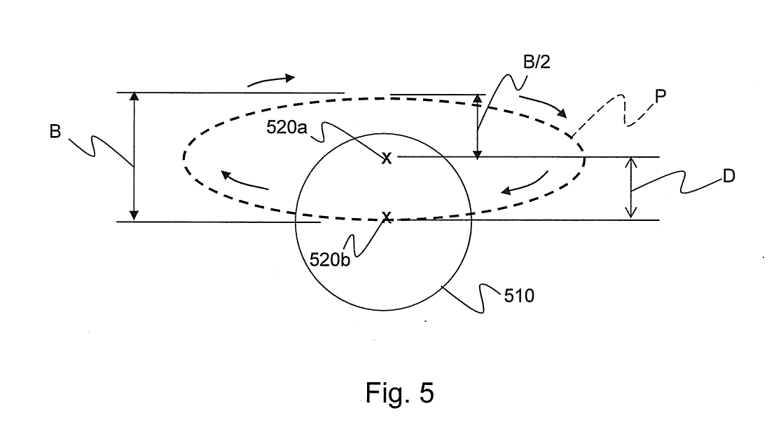

In alternative embodiments (shown in FIG. 5), a first one of the nozzles 520a is positioned above the wafer 510 at or near the center of the elliptical path P through which the center of the wafer 510 moves. In one embodiment, the first nozzle 520a is directly above or below the center of the elliptical path P, and the second nozzle 520b is positioned directly above or below a point along the minor axis B, at a distance D (where D≦R) from the major axis A of path P. Although FIG. 5 only shows two nozzles, additional nozzles may be arranged between nozzle 520a and nozzle 520b. In alternative embodiments (not shown), the nozzles are positioned above or below a portion of the wafer along the major axis of the elliptical path P.

In some embodiments, both of the nozzles 120 are operated with the same spray velocity (and pressure). In other embodiments, the velocity (and pressure) of the spray can be individually controlled for each nozzle 520a, 520b. For example, in one embodiment, a first nozzle 520a at the center of the elliptical path P has a spray droplet velocity of 20 meters/second, and a second nozzle 520b along the minor axis B at a distance R from the center C of the wafer 510 has a spray velocity of 17 meters/second. For the second nozzle, the impact velocity of the droplets relative to the wafer surface is V=(17²+11.8²)^{1/2}=20.7 meters/second. Thus, using a slower spray rate, the impingement velocity of the droplets near the circumference of wafer 510 can be controlled to be very close to the impingement velocity at the center C of the wafer for a 20 meter/second stream. This results in more uniform impingement force.

In some embodiments, the spinner 100 is an “AQUASPIN”™ SU-3X00 series (e.g., Model No. SU-3000 or SU-3100) wet bench wafer cleaning system manufactured by Dainippon Screen Manufacturing Co., Ltd., of Kyoto, Japan, to which a second nozzle and associated feed conduit have been added. Alternatively, other wet bench cleaning equipment may be used, with the addition of a second nozzle, such as wet bench equipment sold by Tokyo Electron Ltd., of Tokyo Japan.

Examples described above include a wet bench apparatus 100 in which the nozzles 120 are stationary, and the wafer 110 is translated in an oscillatory motion. In alternative embodiments a wafer spins about an axis that is stationary, and the nozzles are moved with an oscillatory motion in a plane parallel to the major surface of the wafer.

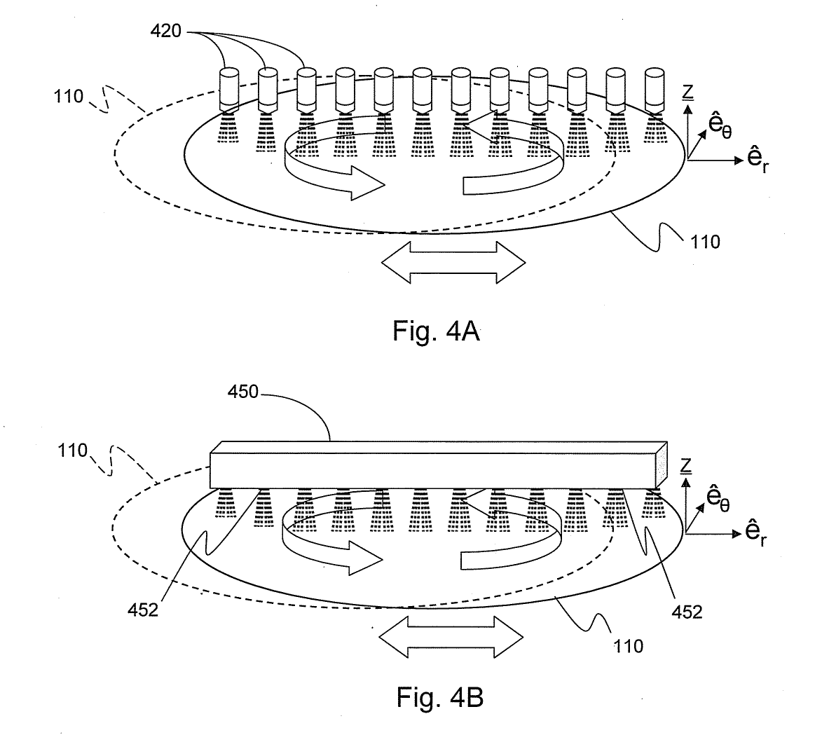

FIGS. 4A and 4B show two different configurations for multiple nozzles or orifices. In FIG. 4A, a plurality of nozzles 420 are arranged in a straight line for spraying the material onto the major surface of the wafer 110, which rotates and translates with an oscillatory motion, as described above. The multiple nozzles 420 may be arranged above the minor axis of the elliptical path traveled by the center of the wafer, for example.

In FIG. 4B, a shower head manifold 450 is provided with a plurality of orifices 452, also arranged in a straight line for spraying the material onto the major surface of the wafer 110, which rotates and translates with an oscillatory motion, as described above. The multiple orifices 452 may be arranged above the minor axis of the elliptical path traveled by the center of the wafer, for example.

One of ordinary skill in the art can readily select either plural separate nozzles 420 or a single manifold 450 with multiple orifices 452 for a given wet bench system, based on the available space and connections for providing the fluid to be dispensed. One of ordinary skill will also appreciate that the plurality of nozzles 420 or orifices 452 may include any number of nozzles or orifices, and the number is not limited by the examples expressly described above.

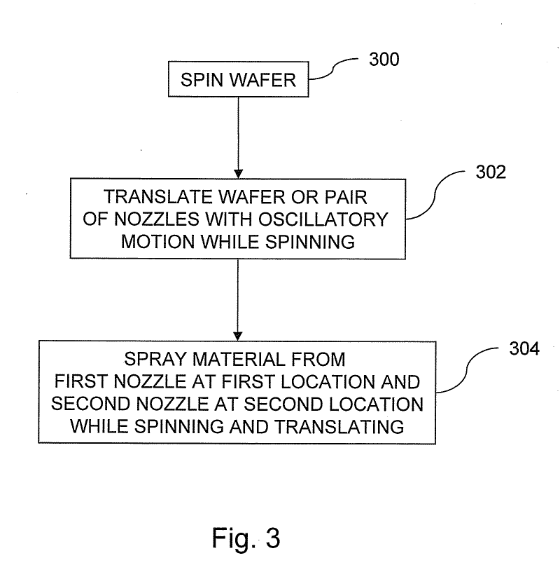

FIG. 3 is a flow chart of an exemplary method.

At step 300, a semiconductor wafer 110 is spun about an axis 112 normal to a major surface 110m of the wafer.

At step 302, either the wafer or the pair of nozzles is translated in a direction parallel to the major surface with an oscillatory motion, while spinning the wafer.

At step 304, a material 130 is sprayed from first and second nozzles 120 or orifices at respective first and second locations on the major surface 110m of the wafer 110 simultaneously while spinning the wafer and translating the wafer or nozzles.

Although an example is described in which the process is a cleaning process, the method may also be used for other material removal tasks, such as etching, planarizing, or thinning steps or the like. Thus, the material 130 may be de-ionized water, a solvent, an oxidizing fluid, an etchant or the like.

By varying the radial position of the spray on the surface of the wafer 110, the system 100 compensates for the gap in relative (droplet relative to surface) velocity between the center C and the circumference of the wafer. By selecting appropriate nozzle positions and parameters of the path P, the process window may be enlarged. The droplet speed for one or both spray nozzles can be reduced. The risk of poly line damage can be reduced.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

What is claimed is:

1. A method comprising:
spinning a semiconductor wafer about an axis normal to a major surface of the wafer;
translating the wafer in a direction parallel to the major surface with an oscillatory motion, while spinning the wafer; and
spraying a material from first and second nozzles or orifices at respective first and second locations on the major surface of the wafer simultaneously while spinning the wafer and translating the wafer.

2. The method of claim 1, wherein
the first nozzle and second nozzle are spaced apart from each other by a distance approximately equal to a radius of the wafer.

3. The method of claim 1, wherein the material is a cleaning solvent.

4. The method of claim 1, wherein the oscillatory motion follows an elliptical path.

5. The method of claim 4, wherein
the first and second nozzles are both positioned substantially directly above or substantially directly below a portion of the wafer along an axis of the elliptical path.

6. The method of claim 5, wherein the first and second nozzles or orifices are positioned substantially directly above or substantially directly below a portion of the wafer along a minor axis of the elliptical path.

7. The method of claim 5, wherein the first nozzle or orifice is positioned substantially directly above or directly below a center of the elliptical path, and the second nozzle or orifice is positioned directly above or directly below or within a distance of 0.14*R of being directly above or directly below the elliptical path, where R is a radius of the wafer.

8. The method of claim 4, wherein the elliptical path has a major axis approximately equal to a diameter of the wafer and a minor axis approximately equal to a radius of the wafer.

9. The method of claim 1, wherein:
the oscillatory motion follows an elliptical path,
the elliptical path has a major axis approximately equal to a diameter of the wafer and a minor axis approximately equal to a radius of the wafer,
the first and second nozzles or orifices are positioned directly above or directly below the portion of the wafer along the minor axis of the elliptical path, and
the first nozzle or orifice and second nozzle or orifice are spaced apart from each other by a distance approximately equal to the radius of the wafer.

10. A method comprising:
spinning a semiconductor wafer about an axis normal to a major surface of the wafer;
translating the wafer or a pair of orifices in a direction parallel to the surface with an oscillatory motion, while spinning the wafer; and
spraying a material from the first nozzle or orifice and the second nozzle or orifice onto the surface of the wafer while simultaneously spinning the wafer and translating the wafer or first and second nozzle or orifice.

11. The method of claim 10, wherein
the material is sprayed at a first location with the first nozzle or orifice; and
the material is sprayed at a second location with the second nozzle or orifice, such that the spraying at the first location and the spraying at the second location do not substantially overlap with each other.

12. The method of claim 11, wherein
the first nozzle or orifice and second nozzle or orifice are spaced apart from each other by a distance approximately equal to a radius of the wafer.

13. The method of claim 10, wherein the oscillatory motion follows an elliptical path.

14. A system comprising:
a spinner for spinning a semiconductor wafer about an axis normal to a major surface of the wafer, the spinner being capable of translating the wafer in a direction parallel to the major surface with an oscillatory motion, while spinning the wafer; and
at least two nozzles or orifices for spraying a material onto the major surface of the wafer simultaneously at two locations while spinning and translating the wafer.

15. The spinner of claim 14, wherein the oscillatory motion is such that a center of the wafer follows an elliptical path.

16. The spinner of claim 15, wherein the at least two nozzles or orifices are positioned directly above or directly below a portion of the wafer along a minor axis of the elliptical path.

17. The spinner of claim 16, wherein the at least two nozzles or orifices are separated from each other by a distance that is greater than or equal to 0.886R, and is less than or equal to R, where R is a radius of the wafer.

18. The spinner of claim 16, wherein the wafer has a radius R, and the elliptical path has a major axis a, such that 1.886R≦a≦2R.

19. The spinner of claim 17, wherein the wafer has a radius R, and the minor axis has a length b, such that 0.22R≦b≦R.

20. The spinner of claim 16, wherein:
the oscillatory motion is such that a center of the wafer follows an elliptical path,
the at least two nozzles or orifices are positioned directly above or directly below a portion of the wafer along a minor axis of the elliptical path,
the at least two nozzles or orifices are separated from each other by a distance that is greater than or equal to 0.886R, and is less than or equal to R, where R is a radius of the wafer, and
the elliptical path has a major axis A, such that 1.886r≦A≦2R, and a minor axis B, such that 0.22R≦B≦R.
